(19) United States
(12) Patent Application Publication
(10) Pub. No.: US 2026/0241691 A1
(43) Pub. Date: Aug. 20, 2026

(54) PRINTHEAD ASSEMBLY

(71) Applicant: BOBST MEX SA, Mex (CH)

(72) Inventors: Pierre HERVÉ, Froideville (CH); Walter URECH, Seengen (CH); Carles SAGUÉS MITJANA, Villars-sous-Yens (CH)

(73) Assignee: BOBST MEX SA, Mex (CH)

(21) Appl. No.: 19/541,556

(22) Filed: Feb. 17, 2026

(30) Foreign Application Priority Data
Feb. 18, 2025 (EP) 25158620.2

(51) Int. Cl. B41J 2/165; B41J 2/14; B41J 2/155; B41J 25/34

(52) U.S. Cl. CPC B41J 2/16507; B41J 2/155; B41J 2/165; B41J 2/16535; B41J 25/34; B41J 2002/14362

(57) ABSTRACT

The invention relates to a printhead assembly (10) comprising a printhead (12) and an interface plate (14) connected to the printhead (12), the printhead (12) having a flange (16) and a housing (18) extending from the flange (16), the interface plate (14) comprising an opening (20) and being placed over the housing (18) such that it abuts at the flange (16), a biasing spring (26) being provided which is connected to the housing (18), abuts at the interface plate (14) and exerts a biasing force onto the interface plate (14) so as to press it against the flange (16).

### CROSS-REFERENCE TO RELATED APPLICATION(S)

This patent application claims the benefit of priority to European Application No. 25158620.2, filed on Feb. 18, 2025, the entirety of which is incorporated herein by reference.

### SUMMARY OF THE DISCLOSURE

The invention relates to a printhead assembly comprising a printhead and an interface plate connected to the printhead, the printhead having a flange and possibly a housing extending from the flange, the interface plate comprising an opening and being placed over the printhead or if available the housing such that it abuts at the flange. Throughout the invention every feature described in connection with the housing can be also realized without a housing providing the according features directly at the printhead.

The printhead of the printhead assembly is an inkjet printhead which is one of the plurality of printheads mounted adjacent each other in a printbar. Generally speaking, the challenge is to mount the printheads close to each other such that their position on the printbar can individually be mechanically adjusted and that there is enough space for all necessary connections (ink, electronics, air).

The interface plate is a component that mainly serves for mechanically connecting the printhead to the printbar. To this end, the printhead is to be fixed to the interface plate.

It is known to glue the interface plate to the printhead. Gluing however is a process that has to be performed under precisely controlled conditions. Further, the interface plate can comprise conduits for supplying media to the printhead so that it has to be ensured that the different conduits are reliably sealed when gluing the interface plate to the printhead. Finally, it has to be ensured that the adhesive used for gluing the interface plate to the printhead is not compromised by the media coming into contact with it.

EP 1 240 024 A1 shows printheads which are provided with snap hooks for latching the printhead to an ink reservoir. As the printed image is digitally adjusted, there is no need for an interface plate.

The object of the invention is to provide a printhead assembly in which the printhead is reliably connected to the interface plate in a simple manner.

In order to solve this object, the printhead assembly as defined above has a biasing spring that is connected to the printhead or the housing, abuts at the interface plate and exerts a biasing force onto the interface plate so as to press it against the flange. The invention is based on the concept of connecting the interface plate to the printhead with mechanical means. The connection does therefore not necessarily also include an adhesive. Nevertheless, this is not excluded and could be in particular used to position the devices. A mechanical connection is very robust regarding its implementation and the process of establishing it, and it can be easily checked if the biasing spring has been installed correctly as compared to verifying that a purely adhesive connection fulfils all requirements.

The biasing spring can be generally U-shaped or being or involving any other shape. A preferred embodiment includes a biasing spring with the free ends being in contact with the interface plate. The biasing spring applies the biasing force to the interface plate at one or more points spaced from each other.

In an exemplary embodiment, the biasing spring has two straight pressing legs and an intermediate spring arm connecting the pressing legs, the spring arm extending over an end of the housing in a distance thereof. The spring arm provides for sufficient flexibility for creating the biasing force while at the same time distributing the biasing force equally between the two pressing legs.

Preferably, a fixing clip is provided which engages at the print head or the housing and at the spring arm. The fixing clip allows applying the required pre-tensioning force onto the spring arm in a very simple manner. Still further, it can be visually inspected very easily if the fixing clip has been properly mounted.

The fixing clip preferably comprises two latching legs and a biasing arm, the latching legs engaging at the printhead or the housing and the biasing arm engaging at the spring arm. The biasing arm is arranged between the latching legs so all forces act in a balanced manner onto the spring arm and the printhead or the housing.

The latching legs each have a hook engaging at a shoulder at the printhead or the housing so that the fixing clip can be mounted very easily by pressing it onto the printhead of the housing.

Preferably, the latching legs each have a positioning portion adjacent the hook so that the maximum overlap between the hook and the shoulder can be controlled in a simple manner.

In an embodiment, a clearance is provided between at least one of the latching legs and the printhead or the housing in the region of the rear end thereof, allowing to displace the fixing clip laterally for disengaging one of the hooks from the shoulder of the printhead or the housing. Thereafter, the fixing clip can be removed, and the interface plate and the printhead can be disassembled.

At least one of the latching legs extends beyond the hook, which allows using the overhanging portion of the latching leg to be locked by other components mounted on the interface plate and/or the housing, and to use the overhanging portion as a lever when the fixing clip is to be disengaged from the housing.

The fixing clip and the biasing spring are preferably formed from sheet metal, with the plane defined by the fixing clip being perpendicular to the planes defined by each of the pressing legs. The pressing legs extend tangentially to the printhead/housing while the plane defined by the fixing clip extends through the centre line of the housing, ensuring that the stiffness of the fixing clip against unintentional disengagement of the hooks from the printhead/housing is high.

Preferably, the biasing arm has a protrusion engaging into a hole in the spring arm so that the biasing arm cannot unintentionally disengage from the spring arm.

In an embodiment, the biasing spring has a centring slot receiving the fixing clip, the centring slot being preferably formed between a bent tab and one of the pressing legs. The centring slot helps maintaining the fixing clip in its proper position should any external forces act on the fixing clip or should there be any vibrations.

The pressing legs are arranged on opposite sides of a plane defined by the fixing clip, allowing to form the centring slot and the bent tab from a single blank of sheet metal and at the same time ensuring that the forces are applied onto the interface plate in a symmetrical manner.

### BRIEF DESCRIPTION OF THE DRAWINGS

The invention will now be described with reference to the enclosed drawings. In the drawings,

FIG. 1 shows a printhead assembly according to an embodiment of the invention in a perspective view;

FIG. 2 shows a top view of the printhead assembly of FIG. 1;

FIG. 3 shows a cross-section A-A through the printhead assembly of FIG. 1;

FIG. 4 shows a side view of the printhead assembly of FIG. 1;

FIG. 5 shows a printhead assembly according to another embodiment of the invention in a perspective view;

FIG. 6 shows a top view of the print head assembly of FIG. 5;

FIG. 7 shows a cross-section A-A through the printhead assembly of FIG. 4; and

FIG. 8 shows a printhead assembly according to another embodiment of the invention in a perspective view.

### DETAILED DESCRIPTION OF EMBODIMENTS

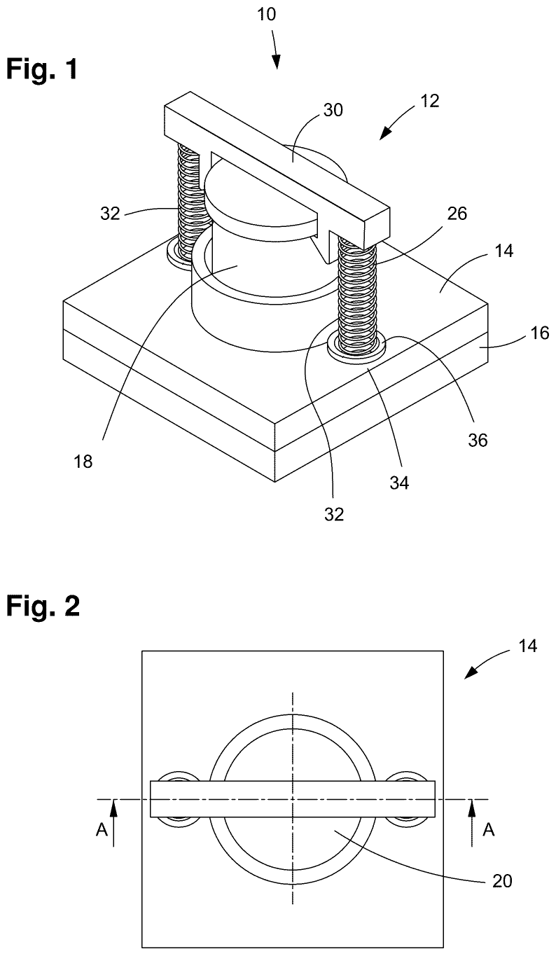

In FIG. 1, a printhead assembly 10 is shown. It comprises a printhead 12 and an interface plate 14.

The printhead 12 is an inkjet printhead which is mounted (typically in a row) together with a plurality of identical printheads to form a printbar (not shown here).

The printhead 12 according to this embodiment comprises a flange 16 and a housing 18. According to the invention the assembly can be also provided without a housing. The side of the flange that is opposite the housing 18 is the side from which ink is ejected towards a substrate, e.g. paper. Details regarding the inner construction of the printhead are not relevant here and will therefore not be discussed in the following.

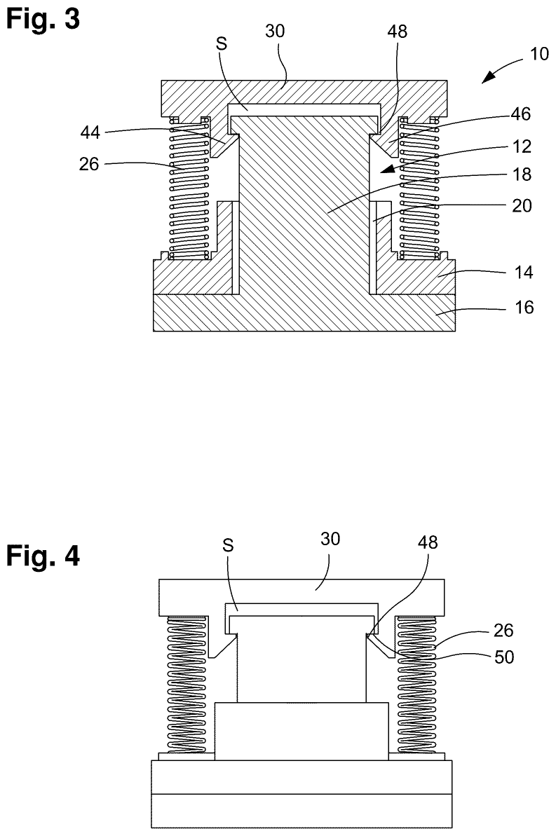

The interface plate 14 (please see also FIG. 3) has a central opening 20 through which the housing 18 extends when the interface plate 14 is mounted to the printhead so as to lie on the flange 16 (please see the condition shown in FIG. 1).

One of the main purposes of the interface plate 14 is to connect the printhead 12 mechanically to the printbar in an adjustable manner. Details of the connection between the printbar and the interface plate 14 are not relevant here; it is only important that the interface plate 14 be firmly mounted to the printhead 12 so that any adjustment made to the interface plate 14 is transferred without play to the printhead 12.

The connection between the printhead 12 and the interface plate 14 comprises two components: first a mechanical engagement between the interface plate 14 and the flange 16 of the printhead 12, and second a biasing force pressing the interface plate 14 against the flange 16, ensuring that the mechanical engagement is maintained and that a frictional engagement is created.

The biasing force is applied to press the interface plate 14 onto the flange 16 of the printhead 12, thereby ensuring that preferably an engagement of parts of the interface plate with the flange are provided. This could be for example one or several projections of the interface plate 14 which remain engaged in according counterparts in the flange, like for example notches.

Further, a frictional engagement can be created, mainly because of seals being arranged between the flange 16 and the interface plate 14. This frictional engagement helps preventing a lateral displacement of the interface plate 14 with respect to the flange 16 of the printhead 12.

Generally speaking, the biasing force is a force that acts so as to “pull” the printhead 12 through the central opening 20. Referring to FIG. 1, the biasing force pulls the printhead 12 upwardly while a reaction force acting on the interface plate 14 tends to press the interface plate 14 downwardly.

The biasing force is generated in this described example with one or several biasing springs 26 (please see in particular FIG. 4).

The biasing spring 26 can be generally U-shaped or show any other adapted shape and has a central area 30 and two pressing legs 32, which extend in parallel at an angle of approx. 90 degrees from opposite ends of the central area 30. At their free ends, each pressing leg 32 has a foot 34.

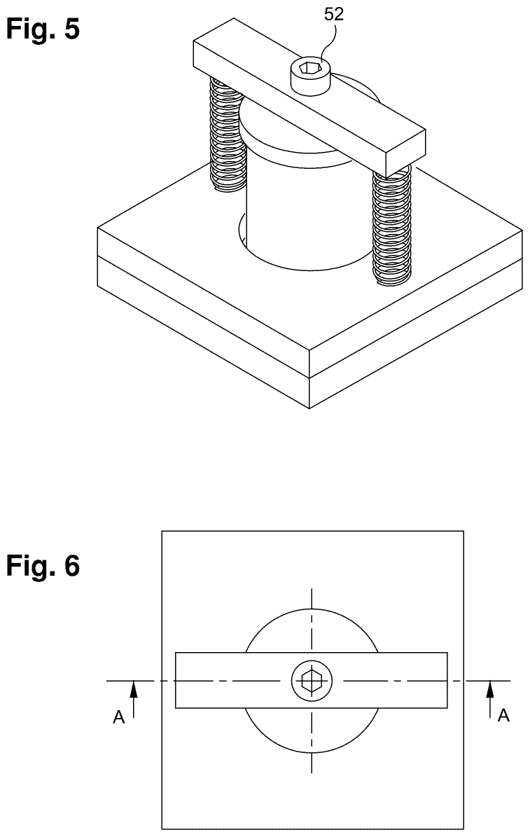

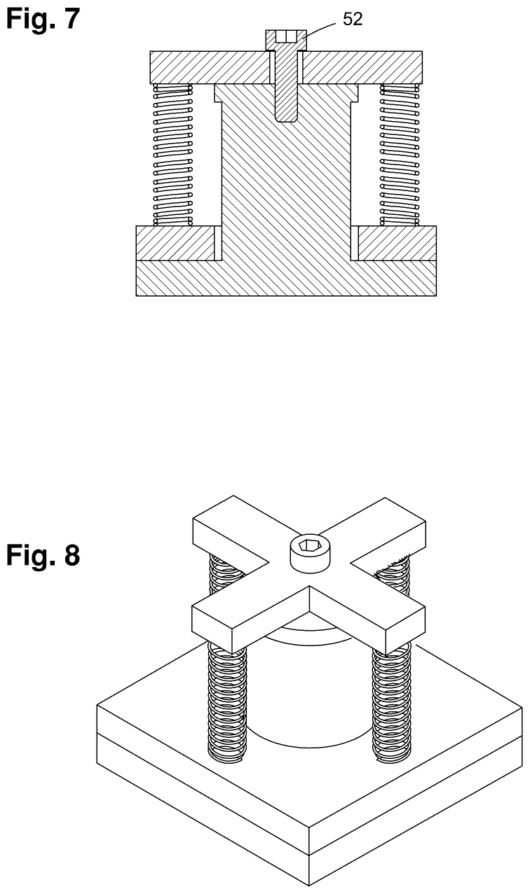

The biasing spring 26 is arranged at the printhead assembly 10 such that the two pressing legs 32 extend along the housing 18 and the central area 30 extends over the free end of the housing 18 at its side facing away from the flange 16. The feet 34 preferably are placed in recesses 36 provided in the upper side of the interface plate 14 (please see in particular FIGS. 4 and 5). As can be seen in FIG. 5, there is a free space S between the rear side of the housing 18 and the central area 30.

The biasing spring 26 is made from metal, e.g. sheet or wire, in particular from stainless steel or from spring steel. The pressing legs 32 extend tangentially to the housing 18, and the central area 30 extends in a plane that is parallel to the planes defined by the interface plate 14 and the flange 16.

The central area 30 can further be fixed or engaged with the housing 18 for example by latching legs 44, 46, extending from the central area and which extend in parallel at an angle of approx. 90 degrees from opposite sites of the central area.

The latching legs 44, 46 can have the same or different lengthes and can have a hook 48 at their free end. The hook 48 engages behind a shoulder 50 of the housing 18.

For assembling the printhead 12 and the interface plate 14, the interface plate 14 is placed over the housing 18 so as to lie on top of the flange 16. Then, the biasing spring 26 is placed over the housing so that the pressing feet 34 engage into the recesses 36.

Thereafter, the centering area 30 is pushed downwardly towards the flange 16 until the hooks 48 engage behind the shoulders 50.

Additionally or instead of using the engagement of the hook 48 with the shoulder 50 the central area 30 can be engaged with the housing by means of a screw 52.

When the hooks 48 engage behind the shoulder 50, the elastic deformation of the spring 26 creates a force which presses the pressing legs against the interface plate 14 (downwardly with respect to the orientation of the printhead assembly in FIGS. 1, 5 and 6). The reaction force which is transmitted via the hooks 50, 54 to the housing 18 and thus to the flange 16 pulls the flange 18 against the interface plate 14 (upwardly with respect to the orientation of the printhead assembly in FIGS. 1, 5 and 6). As a result, the interface plate 14 and the printhead 12 are held in engagement with each other.

1. A printhead assembly comprising a printhead and an interface plate engaged with the printhead, the printhead comprising a flange and possibly a housing extending from the flange, the interface plate being arranged over the printhead or the housing at least partially covering the printhead such that it abuts at the flange, a biasing spring being provided engaging with the printhead or the housing, abutting at the interface plate and exerts a biasing force onto the interface plate so as to press it against the flange.

2. The printhead assembly of claim 1, wherein the interface plate and the flange mechanically engage in a direction parallel to the plane in which the flange and the interface plate extend.

3. The printhead assembly of claim 1, wherein the biasing spring has pressing legs and an intermediate central area connecting pressing legs, the central area extending over an end of the printhead or the housing.

4. The printhead assembly according to claim 3, wherein the biasing spring comprises at least two pressing legs.

5. The printhead assembly of claim 4, wherein each of the pressing legs has a pressing foot and wherein the interface plate has two recesses for receiving the pressing feet.

6. The printhead assembly of claim 4, wherein a fixing clip is provided which engages at the housing and at the spring arm.

7. The printhead assembly according to claim 3, wherein the central area comprises at least one latching legs engaging at the housing or the printhead.

8. The printhead assembly of claim 7, wherein the at least one latching leg comprises a hook engaging at a shoulder at the housing or the printhead.
